(19) United States
(12) Patent Application Publication
(10) Pub. No.: US 2014/0257686 A1
(43) Pub. Date: Sep. 11, 2014

(54) VEHICLE LANE DETERMINATION

(71) Applicant: GM GLOBAL TECHNOLOGY OPERATIONS LLC, Detroit, MI (US)

(72) Inventors: DMITRIY FELDMAN, WEST BLOOMFIELD, MI (US); JAMES N. NICKOLAOU, CLARKSTON, MI (US); KEVIN A. O'DEA, ANN ARBOR, MI (US)

(73) Assignee: GM GLOBAL TECHNOLOGY OPERATIONS LLC, Detroit, MI (US)

(21) Appl. No.: 13/785,909

(22) Filed: Mar. 5, 2013

(51) Int. Cl. G06F 17/00

(52) U.S. Cl. CPC G06F 17/00
USPC 701/300

(57) ABSTRACT

Methods and systems are provided for making lane determinations as to a roadway on which the vehicle is travelling. A determination is made as to a lane of a roadway in which a vehicle is travelling. An identification is made as to an adjacent lane that is adjacent to the lane in which the vehicle is travelling. An assessment is made as to a drivability of the adjacent lane.

### TECHNICAL FIELD

The present disclosure generally relates to the field of vehicles and, more specifically, to methods and systems for making determinations regarding lanes in which a vehicle is travelling.

### BACKGROUND

Many vehicles today have active safety systems, such as a forward collision alert (FCA) system, collision imminent braking system (CIB), collision preparation system (CPS), enhanced collision avoidance (ECA) system, and/or other systems that enhance safety for the vehicle. In certain situations, while a vehicle is travelling along a roadway (such as a highway), it may be desirable to provide information as to a roadway lane in which the vehicle is travelling, along with information as to adjacent lanes, for example as to whether an adjacent lane is drivable. As used in this Application, an adjacent lane is “drivable” if the vehicle would likely be able to safely move into such adjacent lane if desired or necessary (or, alternatively stated, that the adjacent lane is suitable for travel in the same direction in which the vehicle is travelling).

Accordingly, it is desirable to provide improved methods for making determinations regarding vehicle lanes on a roadway in which the vehicle is being driven. It is also desirable to provide systems for making such determinations. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. A determination is made as to a lane of a roadway in which a vehicle is travelling. An identification is made as to an adjacent lane that is adjacent to the lane in which the vehicle is travelling. An assessment is made as to a drivability of the adjacent lane.

In accordance with another exemplary embodiment, a system is provided. The system includes a sensing unit and a processor. The sensing unit is configured to obtain sensing unit data. The processor is coupled to the sensing unit. The processor is configured to, using the sensing unit data: determine a lane of a roadway in which a vehicle is travelling, identify an adjacent lane that is adjacent to the lane in which the vehicle is travelling, and assess a drivability of the adjacent lane.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system, such as an active safety control system, in accordance with an exemplary embodiment;

FIG. 2 is a functional block diagram of a control system that can be used in connection with the vehicle of FIG. 1, in accordance with an exemplary embodiment;

FIG. 3 is a flowchart of a process for making determinations as to a lane on a roadway in which a vehicle is travelling and an assessment of a drivability of adjacent lanes, and that can be used in connection with the vehicle of FIG. 1 and the control system of FIGS. 1 and 2, in accordance with an exemplary embodiment; and

FIGS. 4-7 are illustrations of exemplary sets of roadway lanes and implementations of certain steps of the process of FIG. 3, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

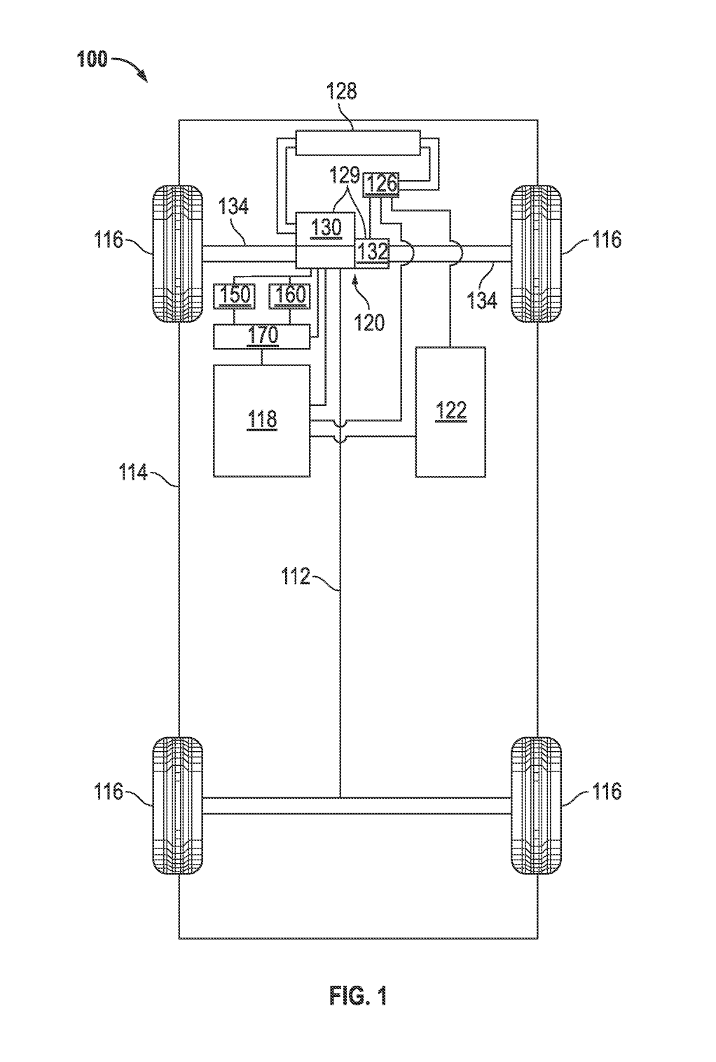

FIG. 1 illustrates a vehicle 100, or automobile, according to an exemplary embodiment. As described in greater detail further below, the vehicle 100 includes a control system 170 that makes determinations pertaining to a lane on a roadway in which the vehicle 100 is travelling as well as a drivability of adjacent lanes. The control system 170 may then provide warnings, recommendations, and/or alerts for the driver, and/or may provide for an automatic lane change and/or other safety features as appropriate based on the lane change determinations.

In certain embodiments, the control system 170 comprises one or more active safety control systems (ASCS), such as, by way of example, a forward collision alert (FCA) system, a collision imminent braking system (CIB), a collision preparation system (CPS), an enhanced collision avoidance (ECA) system, and/or one or more other systems that enhance safety for the vehicle.

With reference again to FIG. 1, the vehicle 100 includes a chassis 112, a body 114, four wheels 116, an electronic control system 118, a steering system 150, a braking system 160, and the above-referenced active safety control system 170. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114.

The vehicle 100 (as well as each of the target vehicles and third vehicles) may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

In the exemplary embodiment illustrated in FIG. 1, the vehicle 100 is a hybrid electric vehicle (HEV), and further includes an actuator assembly 120, an energy storage system (ESS) 122, a power inverter assembly (or inverter) 126, and a radiator 128. The actuator assembly 120 includes at least one electric propulsion system 129 mounted on the chassis 112 that drives the wheels 116. In the depicted embodiment, the actuator assembly 120 includes a combustion engine 130 and an electric motor/generator (or motor) 132. As will be appreciated by one skilled in the art, the electric motor 132 includes a transmission therein, and, although not illustrated, also includes a stator assembly (including conductive coils), a rotor assembly (including a ferromagnetic core), and a cooling fluid or coolant. The stator assembly and/or the rotor assembly within the electric motor 132 may include multiple electromagnetic poles, as is commonly understood.

Still referring to FIG. 1, the combustion engine 130 and the electric motor 132 are integrated such that one or both are mechanically coupled to at least some of the wheels 116 through one or more drive shafts 134. In one embodiment, the vehicle 100 is a “series HEV,” in which the combustion engine 130 is not directly coupled to the transmission, but coupled to a generator (not shown), which is used to power the electric motor 132. In another embodiment, the vehicle 100 is a “parallel HEV,” in which the combustion engine 130 is directly coupled to the transmission by, for example, having the rotor of the electric motor 132 rotationally coupled to the drive shaft of the combustion engine 130.

The ESS 122 is mounted on the chassis 112, and is electrically connected to the inverter 126. The ESS 122 preferably comprises a battery having a pack of battery cells. In one embodiment, the ESS 122 comprises a lithium iron phosphate battery, such as a nanophosphate lithium ion battery. Together the ESS 122 and electric propulsion system(s) 129 provide a drive system to propel the vehicle 100.

The radiator 128 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the combustion engine 130 and the inverter 126.

The steering system 150 is mounted on the chassis 112, and controls steering of the wheels 116. The steering system 150 includes a steering wheel and a steering column (not depicted). The steering wheel receives inputs from a driver of the vehicle. The steering column results in desired steering angles for the wheels 116 via the drive shafts 134 based on the inputs from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lightning units, navigation systems, and the like (also not depicted).

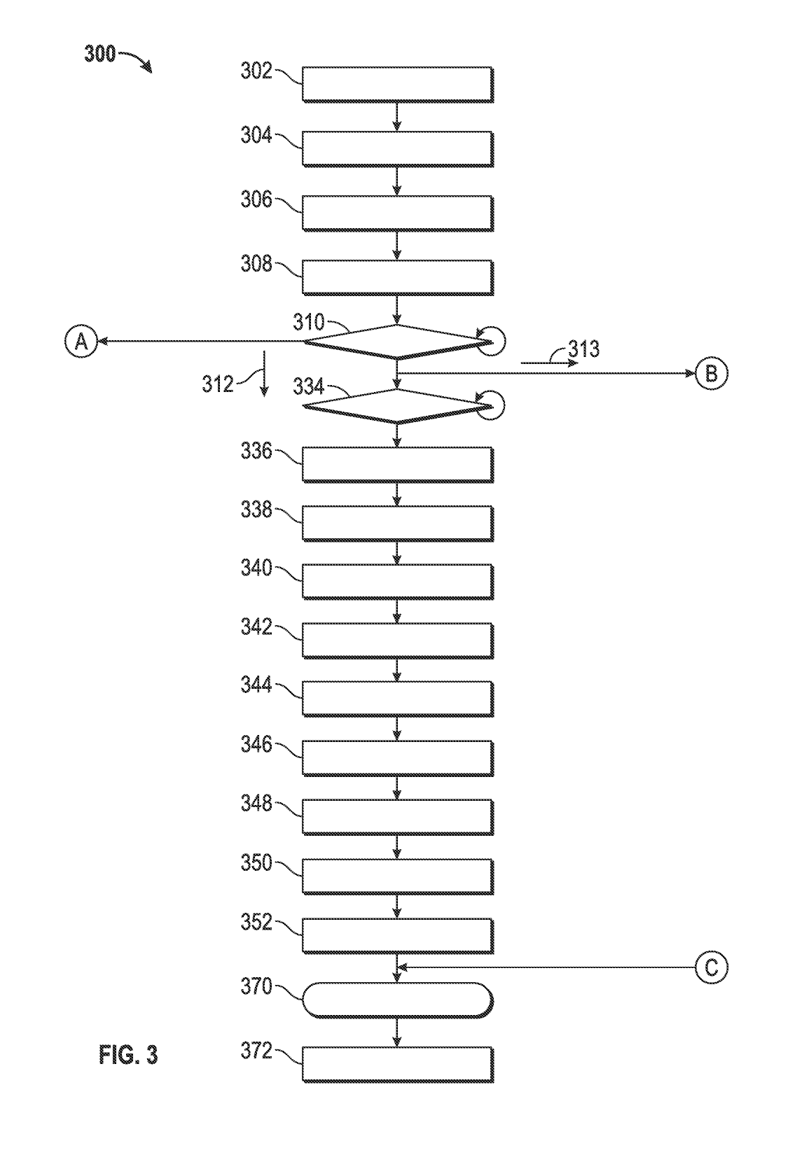

The control system 170 is mounted on the chassis 112. The control system 170 may be coupled to various other vehicle devices and systems, such as, among others, the actuator assembly 120, the steering system 150, the braking system 160, and the electronic control system 118. The control system 170 provides lane determinations for the vehicle 100 while the vehicle 100 is travelling on a roadway, in accordance with the process described further below in connection with FIGS. 3-7. As described in greater detail further below, the lane determinations preferably include determinations as to which lane on the roadway the vehicle is travelling, as well as whether adjacent lanes are deemed to be drivable in the event that a lane change may be desired. In certain embodiments, the control system 170 provides alerts, warnings, and/or recommendations for the driver based on the lane determinations, and/or provides for and/or facilitates automatic lane changes, evasive maneuvers, and/or other functions as appropriate based on the lane determinations. In addition, although not illustrated as such, the control system 170 (and/or one or more components thereof) may be integral with the electronic control system 118 and may also include one or more power sources. The control system 170 preferably conducts various steps of the process 300 and the steps and sub-processes thereof of FIGS. 3-7.

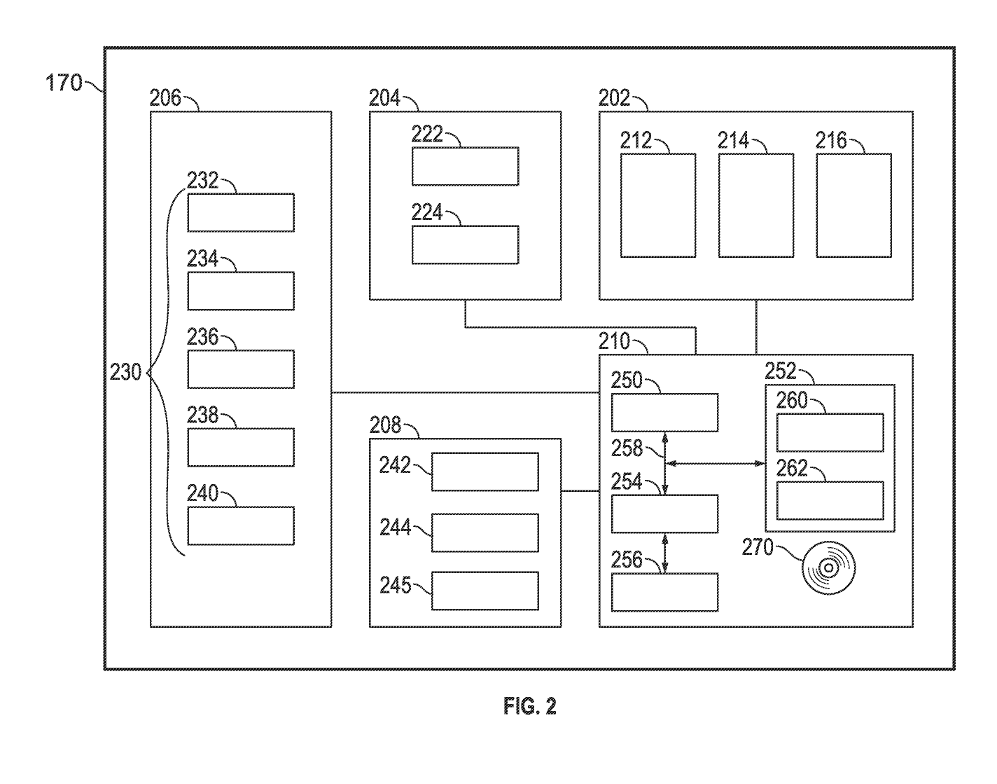

With reference to FIG. 2, a functional block diagram is provided for the control system 170 of FIG. 1, in accordance with an exemplary embodiment. As depicted in FIG. 2, the control system 170 includes a detection unit 202, a communication unit 204, a sensor array 206, a driver notification unit 208, and a controller 210.

The detection unit 202 is used to detect target vehicles in proximity to the vehicle and other nearby vehicles, and to obtain information pertaining thereto (such as information pertaining to position and movement of the target vehicles). The detection unit 202 provides these various types of information to the controller 210 for processing and for use in classifying the target vehicles detected by the detection unit 202 for use in making the lane determinations for the vehicle. In the depicted embodiment, the detection unit 202 includes one or more cameras 212 one or more radar devices 214 (such as long and short range radar detection devices, lasers, and/or ultrasound devices. In certain embodiments, the detection unit 202 may comprise one or more other detection devices 216, such as, by way of example, light detection and ranging (LIDAR) and/or vehicle-to-vehicle (V2V) communications.

The communication unit 204 receives information regarding data as to position, movement, and operation of the vehicle and/or pertaining to target vehicles and/or other vehicles in proximity to the vehicle. Specifically, in one embodiment, the communication unit 204 receives information as to one or more of the following: driver inputs for an accelerator pedal of the vehicle, driver inputs for a brake pedal of the vehicle, a driver's engagement of a steering wheel of the vehicle, information as to lateral and longitudinal positions, velocities, and accelerations of the vehicle, and information as to lateral and longitudinal positions, velocities, and accelerations of target vehicles in proximity to the vehicle. In one embodiment, the communication unit 204 provides these various types of information to the controller 210 for processing and for use in making the lane determinations.

In the depicted embodiment, the communication unit 204 includes an internal communication device 222 and an external communication device 224. The internal communication device 222 preferably comprises a transceiver configured to receive various of the above information from various other devices and systems of the vehicle, outside of the control system 170, via a vehicle communications bus (not depicted). The external communication device 224 preferably comprises a transceiver (such as a vehicle telematics unit and/or a global system (GPS) device) configured to receive various of the above information from a central database and/or from a satellite system via a wireless network (not depicted).

The sensor array 206 measures parameters for data as to a position and movement of the vehicle. Specifically, in one embodiment, the sensor array 206 comprises various sensors 230 that measure values of parameters pertaining to one or more of the following: driver inputs for an accelerator pedal of the vehicle, driver inputs for a brake pedal of the vehicle, a driver's engagement of a steering wheel of the vehicle, and information as to lateral and longitudinal positions, velocities, and accelerations of the vehicle, and information as to lateral and longitudinal positions, velocities, and accelerations of the vehicle.

In one embodiment, the sensor array 206 provides these various types of information to the controller 210 for processing and for use in making the lane determinations. Per the discussion above, in certain embodiments, some or all of this information may be provided instead by the communication unit 204. As depicted in FIG. 2, the sensor array 206 includes one or more brake pedal sensors 232, accelerator pedal sensors 234, steering angle sensors 236, wheel speed sensors 238, yaw rate sensors, and/or accelerometers 240.

The brake pedal sensors 232 are coupled to or part of the braking system 160 of FIG. 1. The brake pedal sensors 232 include one or more brake pedal position sensors and/or brake pedal travel sensors. The brake pedal position sensor measures a position of the brake pedal or an indication as to how far the brake pedal has traveled when the operator applies force to the brake pedal. The brake pedal force sensor measures an amount of force applied to the brake pedal by the driver of the vehicle.

The accelerator pedal sensors 234 are coupled to an accelerator pedal of the vehicle. The accelerator pedal sensors 234 include one or more accelerator pedal position sensors and/or accelerator pedal travel sensors. The accelerator pedal position sensor measures a position of the accelerator pedal or an indication as to how far the accelerator pedal has traveled when the operator engages the accelerator pedal. The accelerator pedal force sensor measures an amount of force applied to the accelerator pedal by the driver of the vehicle. In certain embodiments, an accelerator pedal position sensor may be used without an accelerator pedal force sensor, or vice versa.

The steering angle sensors 236 are coupled to or part of the steering system 150 of FIG. 1, and are preferably coupled to a steering wheel or steering column thereof. The steering angle sensors 236 measure an angular position of the steering column and/or steering wheel or an indication as to how far the steering wheel is turned (preferably, a steering wheel angle and gradient) when the operator engages a steering wheel of the steering column.

The wheel speed sensors 238 are coupled to one or more of the wheels 116 of FIG. 1. The wheel speed sensors 238 measure wheel speeds of the wheels 115 while the vehicle is being operated. In one embodiment, each wheel speed sensor 238 measures a speed (or velocity) of a different respective wheel 116.

The accelerometers 240 measure an acceleration of the vehicle. In certain embodiments, the accelerometers measure lateral and longitudinal acceleration of the vehicle. In certain other embodiments, vehicle acceleration values are instead calculated by the controller 210 using velocity values, for example as calculated using the wheel speed values obtained from the wheel speed sensors 238.

The driver notification unit 208 provides notifications/alerts/warnings to the driver and other occupants of the vehicle as appropriate based on the lane determinations. For example, in certain embodiments, the driver notification unit 208 may provide a display on a navigation unit and/or a haptic or human-machine-interface (HMI) unit of the vehicle as to which of the lanes of the roadway the vehicle is currently being driven, and/or an indication as to whether adjacent lanes are considered to be drivable (for example, for a possible lane change for the vehicle). In addition, in certain embodiments, the driver notification unit 208 may provide an audible, haptic (or HMI), or visual alert to the driver as to whether an adjacent lane is deemed to be drivable when it is deemed that the driver may wish to make a lane change, for example if the driver has engaged a turn signal for the vehicle and/or the control system indicates that a collision may be imminent. In other embodiments, such notification may be provided via a haptic or HMI notification, for example via a telematics device located within the vehicle.

In the depicted embodiment, the driver notification unit 208 includes an audio component 242, a visual component 244, and a haptic (or HMI) component 245. The audio component 242 provides audio notifications/alerts/warnings (such as an audible alarm, a beeping sound, or a verbal description), and the visual component 244 provides visual notifications/alerts/warnings (such as an illuminated light, a flashing light, or a visual description). The haptic (or HMI) component 245 preferably provides audio notifications, alerts, and warnings via vibration, for example, on a steering wheel and seats of the vehicle.

The controller 210 is coupled to the detection unit 202, the communication unit 204, the sensor array 206, and the driver notification unit 208. The controller 210 processes the data and information received from the detection unit 202, the communication unit 204, and the sensor array 206 and makes lane determinations using the various data and information, in accordance with the steps of the process described further below in connection with FIGS. 3-7. The controller 210 also utilizes the lane determinations to provide appropriate notifications/alerts/warnings via instructions provided to the driver notification unit 208 and also to control one or more aspects of active safety control (such as automatic steering and/or automatic braking) via instructions provided to the steering system 150 and/or the braking system 160 of FIG. 1 (and/or one or more other active safety systems, such as collision imminent braking systems (CIB), collision preparation systems (CPS), enhanced collision avoidance (ECA) systems, adaptive cruise control (ACC), lane keep assist (LKA), lane centering (LC), and forward collision alert (FCA) systems).

As depicted in FIG. 2, the controller 210 comprises a computer system. In certain embodiments, the controller 210 may also include one or more of the detection unit 202, the communication unit 204, the sensor array 206, the driver notification unit 208, and/or components thereof. In addition, it will be appreciated that the controller 210 may otherwise differ from the embodiment depicted in FIG. 2. For example, the controller 210 may be coupled to or may otherwise utilize one or more remote computer systems and/or other control systems.

In the depicted embodiment, the computer system of the controller 210 includes a processor 250, a memory 252, an interface 254, a storage device 256, and a bus 258. The processor 250 performs the computation and control functions of the controller 210, and may comprise any type of processor or multiple processors, single integrated circuits such as a microprocessor, or any suitable number of integrated circuit devices and/or circuit boards working in cooperation to accomplish the functions of a processing unit. During operation, the processor 250 executes one or more programs 260 contained within the memory 252 and, as such, controls the general operation of the controller 210 and the computer system of the controller 210, preferably in executing the steps of the processes described herein, such as the steps of the process 300 (and any sub-processes thereof) in connection with FIGS. 3-7.

The memory 252 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 252 is located on and/or co-located on the same computer chip as the processor 250. In the depicted embodiment, the memory 252 stores the above-referenced program 260 along with one or more stored values 262 for use in making the lane determinations. In one such embodiment, the stored values 262 comprise map data that includes a mapping of the roadway on which the vehicle is travelling.

The bus 258 serves to transmit programs, data, status and other information or signals between the various components of the computer system of the controller 210. The interface 254 allows communication to the computer system of the controller 210, for example from a system driver and/or another computer system, and can be implemented using any suitable method and apparatus. It can include one or more network interfaces to communicate with other systems or components. The interface 254 may also include one or more network interfaces to communicate with technicians, and/or one or more storage interfaces to connect to storage apparatuses, such as the storage device 256.

The storage device 256 can be any suitable type of storage apparatus, including direct access storage devices such as hard disk drives, flash systems, floppy disk drives and optical disk drives. In one exemplary embodiment, the storage device 256 comprises a program product from which memory 252 can receive a program 260 that executes one or more embodiments of one or more processes of the present disclosure, such as the steps of the process 300 (and any sub-processes thereof) of FIGS. 3-7, described further below. In another exemplary embodiment, the program product may be directly stored in and/or otherwise accessed by the memory 252 and/or a disk (e.g., disk 270), such as that referenced below.

The bus 258 can be any suitable physical or logical means of connecting computer systems and components. This includes, but is not limited to, direct hard-wired connections, fiber optics, infrared and wireless bus technologies. During operation, the program 260 is stored in the memory 252 and executed by the processor 250.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 250) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 210 may also otherwise differ from the embodiment depicted in FIG. 2, for example in that the computer system of the controller 210 may be coupled to or may otherwise utilize one or more remote computer systems and/or other control systems.

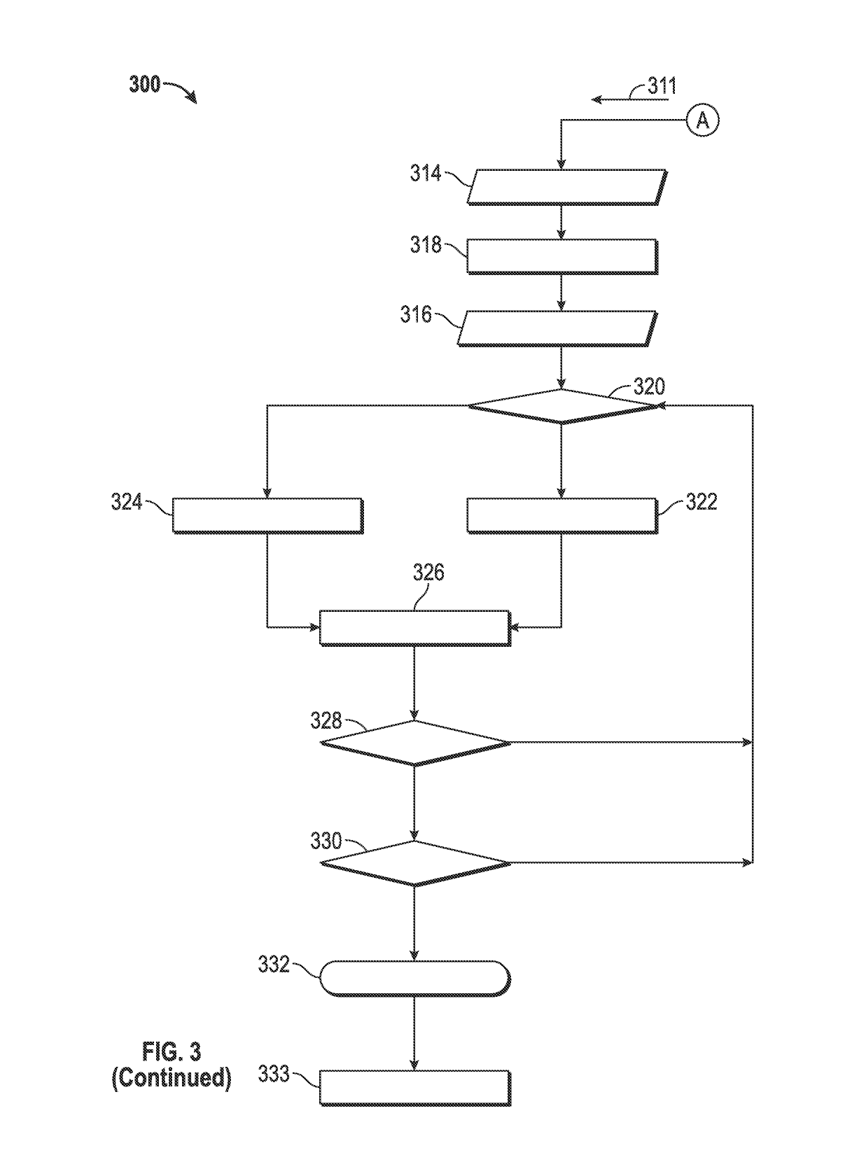

FIG. 3 is a flowchart of a process 300 for making lane determinations for a vehicle travelling on a roadway, in accordance with an exemplary embodiment. The process 300 will also be described further below in connection with FIGS. 4-7, which depict the vehicle 100 of FIG. 1 travelling on a roadway 400 with three lanes 404, 406, and 408. It will be appreciated that this example may be similarly extended to any number of lanes, with similar inquiries as to whether other adjacent lanes are also drivable (such as two lanes over to the right, two lanes over to the left, three lanes over to the right, three lanes over the left, and so on). The process 300 can be implemented in connection with the vehicle 100 of FIGS. 1 and 2 and the control system 170 of FIGS. 1 and 2. The process 300 is preferably performed continuously during a current drive cycle (or ignition cycle) of the vehicle.

The process includes the step of obtaining vehicle map data (step 302). The map data preferably includes data pertaining to various roadways, including those on which the vehicle is travelling. The map data preferably includes information as to the number of lanes in the roadway (such as a roadway in which the vehicle is travelling), lane width and other measurements of the roadway, curvature in the roadway, any known structures of the roadway (e.g. guard rails, poles, medians, lights, barriers, sign posts, and the like). In one embodiment, the map data is stored as stored values 262 in the memory 252 of FIG. 2. In certain embodiments, the map data is obtained via the communication unit 204 of FIG. 2, for example from a central server that is remote from the vehicle. The map data is preferably supplied to the processor 250 of FIG. 2 for processing.

In addition, camera data is obtained (step 304). The camera data preferably includes data pertaining to images taken by the cameras 212 of FIG. 2 of the vehicle while the vehicle is being driven on the roadway. The camera data specifically includes images of lane markers on the roadway, and in certain embodiments may also include images of other vehicles on the roadway and/or of road edges, guard rails, lights, barriers, sign posts, and the like. The camera data is preferably supplied to the processor 250 of FIG. 2 for processing. While the terms “camera” and “camera data” are used at various times in this Application, it will be appreciated that radar, Lidar and/or other devices may also be used for similar data (e.g. for sensing lane markers, lane boundaries, and the like).

In addition, radar data is obtained (step 306). The radar data preferably includes data from the radar units 214 of FIG. 2 of the vehicle while the vehicle is being driving on the roadway. The radar data specifically includes radar data pertaining to road edges, guard rails, lights, barriers, sign posts, and the like that indicate an edge or termination of a width of the roadway on which the vehicle is travelling. The radar data is preferably supplied to the processor 250 of FIG. 2 for processing. In addition, the camera data and the radar data may also pertain to roadside details and objects such as lights, barriers, sign posts, and the like that can be detected by camera, Lidar, and radar. While the terms “radar” and “radar data” are used at various times in this Application, it will be appreciated that camera, Lidar and/or other devices may also be used for similar data (e.g. for detecting lane edges, other vehicles, obstacles, objects, and the like).

The process also includes the step of obtaining vehicle data that may be used in determining and tracking a position and/or movement of the vehicle (step 308). The vehicle data preferably includes data and related information pertaining to lateral and longitudinal positions, velocities, and accelerations of the vehicle (preferably pertaining to measurements of one or more sensors 230, such as the wheel speed sensors 238 and/or accelerometers 240 of FIG. 2 and/or via communications provided by the communication unit 204 of FIG. 2), as well as measures of a driver's engagement of a brake pedal, accelerator pedal, and steering wheel of the vehicle (preferably pertaining to measurements of various sensors 230, such as the brake pedal sensors 232, the accelerator pedal sensors 234, and the steering angle sensors 236 of FIG. 2, respectively and/or via communications provided by the communication unit 204 of FIG. 2). The vehicle data is preferably supplied to the processor 250 of FIG. 2 for processing.

In certain embodiments, a determination is made as to whether the vehicle is travelling on a highway (step 310). As referred to in this Application, a highway comprises a roadway in which traffic is allowed to move relatively freely without stop lights, stop signs, and the like. In one embodiment, the determination of step 310 is made by the processor 250 of FIG. 2 using the map data of step 302. In certain embodiments, the determination of step 310 may be made via by a history of prior travel by the vehicle and/or by other vehicles (for example, stored in the memory 252 of FIG. 2), by vehicle to vehicle communications, by vehicle to infrastructure communications (e.g., by communication with a cellular tower), and the like. In certain embodiments, if it is determined in step 310 that the vehicle is travelling on a highway, then the process proceeds to step 314, described directly below. Conversely, in certain embodiments, if it is determined in step 310 that the vehicle is not travelling on a highway, then step 310 repeats until the vehicle is travelling on a highway. However, in certain other embodiments, the remaining steps may be implemented regardless of whether the roadway comprises a “highway” under this definition, and in such embodiments each of the remaining steps of the process may be conducted with regard to the roadway (and each of the subsequent references to “highway” may be interpreted as referring to “roadway” in such embodiments).

Once it is determined in step 310 that the vehicle is travelling on a highway, the process proceeds along a first path 311, in which a determination is made as to a number of lanes on a current stretch of the highway in which the vehicle is travelling (step 314). In one embodiment, the determination of step 314 is a determination as to a total number of lanes of a current stretch of highway with traffic flowing in the same direction as the direction of travel of the vehicle. Also in one embodiment, the determination of step 314 is made by the processor 250 of FIG. 2 based on the map data of step 302. In certain other embodiments, the determination of step 314 may be made using data pertaining to a history of prior travel by the vehicle and/or by other vehicles (for example, stored in the memory 252 of FIG. 2), by vehicle to vehicle communications, by vehicle to infrastructure communications (e.g., by communication with a cellular tower), and the like.

In addition, a determination is made as to whether an entrance used by the vehicle is on the right side versus the left side of the vehicle (step 316). In one embodiment, the entrance refers to an entrance ramp of the vehicle. In other embodiment, the entrance may pertain to any bifurcation or place in which the road lane opens up or closes (including, for example, entrance ramps as well as exit ramps, lane merges, lane openings, lane splits, and the like). In one embodiment, the determination of step 316 is made by the processor 250 of FIG. 2 based on the map data of step 302. In certain other embodiments, the processor 250 makes the determination of step 302 based on the vehicle data of step 302 from the sensor array 206 (e.g., by tracking the movement of the vehicle and/or of the steering wheel, the tires, or the like) and/or from the communication unit 204 of FIG. 2 (e.g., from a GPS device). In yet other embodiments, the determination of step 316 may be made using data pertaining to a history of prior travel by the vehicle and/or by other vehicles (for example, stored in the memory 252 of FIG. 2), by vehicle to vehicle communications, by vehicle to infrastructure communications (e.g., by communication with a cellular tower), and the like. In certain embodiments, this determination may by obtaining the navigation route planned by the driver and determining the most probable path for the direction of travel.

A lateral displacement of the vehicle is determined (step 318). The lateral displacement of the vehicle is preferably determined by the processor 250 of FIG. 2 using values of the position of the vehicle over short time intervals as obtained from the sensor array 206 (e.g., via the accelerometers 240 of FIG. 2) and/or from the communication unit 204 of FIG. 2 (e.g., from a GPS device).

A determination is made as to whether camera data is available for lane markers of lanes that are adjacent to the vehicle (step 320). The determination of step 320 is preferably made by the processor 250 of FIG. 2 with respect to whether the camera data of step 304 is available from the cameras 212 of FIG. 2 for lane markers of the adjacent lanes on the highway. As used this throughout this Application, the term “lane marker” shall include any indicator and/or marker of a lane of travel along a roadway or other path for vehicles, and includes, among various other types of lane markers, dashed lines, solid lines, combinations of dashed and/or solid lines, paint markings, rumble strips, lane divider poles, curbs, bumps, drainage troughs, other markers commonly known as “Botts Dotts” and “Cat's Eyes”, and any other marker or indicator that can be detected by various safety sensors and/or used as a lane indicator and/or marking.

If it is determined in step 320 that the camera or Lidar data is available, then a relative lateral displacement of the vehicle with respect to the lane markers is determined (step 322). The relative lateral displacement is preferably determined by the processor 250 of FIG. 2 using the lateral displacement of step 318 and the camera data. The process then skips to step 326, discussed further below.

Conversely, if it is determined in step 320 that the camera data is not available, then the relative lateral displacement of the vehicle with respect to the lane markers is estimated (step 324). Specifically, during step 324, the estimation of the relative lateral displacement is made using the lateral displacement of step 318 and an average width for the lanes. In certain embodiments, the average width is stored as one of the stored values 262 in the memory 252 of FIG. 2, for example as obtained via the map data, prior history, vehicle to vehicle communications, and/or vehicle to infrastructure communications discussed above. In some embodiments, the average lane width pertains to a known average width of lanes of the highway. In other embodiments, the average lane width pertains to an average width of lanes generally, across various roadway. The process then proceeds to step 326, discussed directly below.

During step 326, the radar data of step 306 is analyzed, and lane markers are estimated based on the radar or Lidar data (for example, corresponding to road edges, guard rails, or the like identified in the radar or Lidar data). This analysis is preferably performed by the processor 250 of FIG. 2. In addition, a determination is made as to whether the relative lateral displacement (as determined in step 322 or step 324, as discussed above) is consistent with the radar-based determinations of step 326 pertaining to the position of guard rails or road edges for the lane on which the vehicle is travelling and the adjacent lanes (step 328). The determination of step 328 is preferably made by the processor 250 of FIG. 2. By way of one example, the map data includes details about the number of lanes and the bifurcation or merging points of the lanes, while a change in the number of lanes on a freeway indicates a lane is about to merge with another lane. The processor 250 of FIG. 2 thus may use this point along with a camera, radar, or Lidar detection of a merge (from the camera or Lidar data) as confirmation that a lane is going away via a lane merge. By way of a second example, in the case of leading traffic the processor 250 of FIG. 2 may be able to estimate the number of lanes by using “bread crumb” data (for example, as described further below in connection with step 360) and compare it with the map data along with the distance to roadside objects (for example, from radar, lidar, ultrasound, or camera data). Likewise, in certain embodiments, camera detection of construction merge signs, construction lane marking (by size or color) or by flashing arrows by camera detection may also be similarly used by the processor 250 for an indication of the number of lanes and any changes thereof. If the relative lateral displacement is determined to be consistent with the radar data, then the process proceeds to step 330, discussed below. Conversely, if the relative lateral displacement is determined to not be consistent with the radar data, then the process returns to the above-described step 320, and steps 320-328 repeat in a new iteration, with updated data.

In addition, a determination is made as to whether the relative lateral displacement (as determined in step 322 or step 324, as discussed above) is consistent with the map data from step 302 pertaining to where the lane makers are indicated on the map for the lane on which the vehicle is travelling and the adjacent lanes (step 330). The determination of step 330 is preferably made by the processor 250 of FIG. 2. If the relative lateral displacement and estimated forward directory of targets (for example, as discussed further below in connection with FIGS. 4-7) is determined to be consistent with the map data, then the process proceeds to step 332, discussed below. Conversely, if the relative lateral displacement is determined to not be consistent with the map data, then the process returns to the above-described step 320, and steps 320-330 repeat in a new iteration, with updated data.

During step 332, an output is provided that indicates the lane on the highway in which the vehicle is travelling. The output is preferably provided at least in part by the processor 250 of FIG. 2. In addition, in certain embodiments, one or more actions are taken based on the output (step 333). The actions may comprise an audio and/or visual notification (such as a verbal and/or audible notification provided by the driver notification unit 208 of FIG. 2. In addition, the action may include one or more remedial actions under certain conditions, for example via an active safety procedure such as, by way of example, a collision imminent braking system (CIB), collision preparation system (CPS), enhanced collision avoidance (ECA) system, adaptive cruise control (ACC), or forward collision alert (FCA).

With reference again to step 310, once it is determined in step 310 that the vehicle is travelling on a highway, the process also proceeds along a second path 312 beginning with step 334. During step 334, a determination is made as to whether camera or Lidar data is available for lane markers of lanes that are adjacent to the vehicle (e.g. pertaining to the color of the lane markers and/or as to whether the lane markers have solid or dashed lines, and/or as to the number of lines, and/or as to a width of the lane markers). Similar to the above-described step 320, the determination of step 334 is preferably made by the processor 250 of FIG. 2 with respect to whether the camera data of step 304 is available from the cameras 212 of FIG. 2 for lane markers of the adjacent lanes on the highway.

If it is determined in step 334 that the camera or Lidar data is available, then determinations are made as to physical characteristics of the lane markers (step 336). Specifically, during step 336, determinations are made as to characteristics of the lane markers for the lane in which the vehicle is travelling as well as the adjacent lanes (i.e., the lane immediately to the left of the vehicle lane, and the lane immediately to the right of the vehicle lane). The characteristics preferably include whether the lane marker is a dashed line or a solid line, as well as the color of the lane marker (e.g., white or yellow) and the width of the lane markers. The determinations of step 336 are preferably made by the processor 250 of FIG. 2 using the camera data of step 304 from the cameras 212 of FIG. 2.

In addition, with respect to each of the adjacent lanes, a determination is made as to a likelihood or probability as to whether the adjacent lane is considered to be drivable for the vehicle (step 338). As mentioned above, as used in this Application, an adjacent lane is “drivable” if the vehicle would likely be able to safely move into such adjacent lane if desired or necessary (or, alternatively stated, that the adjacent lane is suitable for travel in the same direction in which the vehicle is travelling). For example, an adjacent lane would generally be considered to be “drivable” if the lane is denoted for travel in the same direction as the vehicle, and in which there are no fixed obstacles that could cause a collision. In general, an adjacent lane is provided with a relatively higher probability of drivability the more the following factors are present: the lane marker separating the vehicle's current lane from the adjacent lane is dashed rather than solid (e.g., as determined using the camera data), there are “bread crumbs” (e.g. from the tracking of step 360, described further below) of leading vehicles on the highway travelling in the same direction as the vehicle, the lane marker separating the vehicle's current lane from the adjacent lane is white rather than yellow, blue, or orange (e.g., as determined using the camera data), no stationary objects are detected in the adjacent lane (e.g., using the radar data), and other vehicles are travelling in the adjacent lane in the same direction as the vehicle 100 of FIG. 1 (e.g., using the radar data). Conversely, in general an adjacent lane is provided with a relatively lower probability of drivability the more the following factors are present: the lane marker separating the vehicle's current lane from the adjacent lane is solid (e.g., as determined using the camera data), the lane marker separating the vehicle's current lane from the adjacent lane is yellow, blue, or orange (e.g., as determined using the camera data), stationary objects are detected in the adjacent lane (e.g., using the radar data), and other vehicles are not travelling in the adjacent lane in the same direction as the vehicle 100 of FIG. 1 (e.g., using the radar data). Moreover, the width of the lane markers is also preferably used in the analysis. For example, in certain regions, the exit/entrance areas often use paint lane markings that are typically painted twice as wide as typical or average paint lane markings to help the driver understand. Applicant further notes that various sensors and technologies from commonly owned and commonly assigned U.S. Pat. No. 8,306,672 (entitled Vehicular Terrain Detection System and Method, filed on Sep. 9, 2009, and issued on Nov. 6, 2012), incorporated by reference herein in its entirety, may be used in this step and in other steps of the processes described in this Application. For example, surface predictions can be ascertained from radar and Lidar data, such as that described in U.S. Pat. No. 8,306,672, and/or other radar, Lidar data and/or camera data pertaining to reflection and/or lack of reflection from the roadway. For example, such radar, Lidar, and/or camera data can be used to detect reflective energy in the roadway, which can be used to detect objects such as a curb and/or moving targets or vehicles. The data can similarly be used to track movement, velocity, and acceleration/deceleration of the moving target or vehicle. For example, reflectance data obtained by the radar, Lidar, camera and/or other sensors may reflect different colors for different portions of the roadway to identify objects on such portions of the roadway. For example, in one embodiment, the reflectance data may yield a first color (for example, orange, in one embodiment) for a fixed object (such as a guard rail), a second color (for example, green, in one embodiment) for an accelerating object, a third color (for example, yellow, in embodiment) for an object or vehicle that is decelerating, and so on. These may vary in other embodiments. In certain embodiments, such data can be used in combination with the bread crumb techniques described herein for tracking objects and vehicles.

Exemplary embodiments of such drivability determinations are discussed below with reference to steps 340-352 of FIG. 3. These examples are also discussed with reference to the exemplary illustration in FIG. 4. Specifically, FIG. 4 depicts the vehicle 100 of FIG. 1 as driven on a highway 400. The vehicle 100 is travelling in a designated direction 402 within a current lane 404. Adjacent lanes 406 and 408 are depicted to the right and to the left, respectively, of the current lane 404. Various lane markers are depicted in FIG. 4, including a first lane marker 411 on an outer edge of a left adjacent lane 408, a second lane marker 412 separating the left adjacent lane 408 from the current lane 404, a third lane marker 413 separating the current lane 404 from a right adjacent lane 406, and a fourth lane marker 414 on an outer edge of the right adjacent lane 406. As depicted in FIG. 4, the left adjacent lane 408 is considered to not be drivable, because the lane is designated for travel in the opposite direction of the vehicle (e.g., as indicated by the solid line for the second lane marker 412). Also as depicted in FIG. 4, the right adjacent lane 406 is determined to be drivable, as evidenced by the dashed line for the third lane marker 413 as well as by tracking a different vehicle 415 that is moving in the same general direction as the vehicle 100.

Returning to FIG. 1, in one example, if only data as to the second lane marker 412 of FIG. 4 is available and it is determined that in step 338 that there is at least a predetermined probability that the second lane marker 412 is solid, then the left adjacent lane 408 of FIG. 4 is determined to be drivable (step 340). In one embodiment, the predetermined probability may be equal to seventy-five percent; however, the predetermined probability may vary and/or be adjustable in various embodiments. This determination is preferably made by the processor 250 of FIG. 2.

By way of further example, if only data as to the third lane marker 413 of FIG. 4 is available and it is determined that in step 338 that there is at least a predetermined probability that the third lane marker 413 is solid, then the right adjacent lane 406 of FIG. 4 is determined to be drivable (step 342). In one embodiment, the predetermined probability may be equal, for example, to seventy five percent; however, the predetermined probability may vary and/or be adjustable in various embodiments. This determination is preferably made by the processor 250 of FIG. 2.

By way of additional example, the left adjacent lane 408 is determined to be drivable if data as to the first lane marker 411 and the second lane marker 412 are available, the first lane marker 411 is determined to be solid with at least a predetermined probability, and an absolute value of a difference between a second lane marker 412 offset (i.e., an offset or distance between the vehicle 100 and the second lane marker 412) and a first lane marker 411 offset (i.e., an offset or distance between the vehicle 100 and the first lane marker 411) is greater than a predetermined threshold (step 344). In one example, the predetermined probability may be equal, for example, to seventy-five percent and the predetermined threshold of step 344 may be equal to nominal road class lane widths (or average widths); however, this may vary in other embodiments.

As another example, the right adjacent lane 406 is determined to be drivable if data as to the third lane marker 413 and the fourth lane marker 414 are available, the fourth lane marker 414 is determined to be solid with at least a predetermined probability (for example, a seventy five percent probability, in one embodiment, although this may vary in other embodiments) and an absolute value of a difference between a third lane marker 413 offset (i.e., an offset or distance between the vehicle 100 and the third lane marker 413) and a fourth lane marker 414 offset (i.e., an offset or distance between the vehicle 100 and the fourth lane marker 414) is greater than a predetermined threshold (step 346). In one example, the predetermined threshold of step 346 is equal to approximately equal to a nominal road class (or average) lane width; however, this may vary in other embodiments.

As a further example, the left adjacent lane 408 is determined to be drivable if data as to the first lane marker 411 and the second lane marker 412 are available, the fourth lane marker 414 is determined to be dashed with at least a predetermined probability, and an absolute value of a difference between the above-referenced third lane marker 413 offset (i.e., an offset or distance between the vehicle 100 and the third lane marker 413) and the above-referenced fourth lane marker 414 offset (i.e., an offset or distance between the vehicle 100 and the fourth lane marker 414) is greater than a predetermined threshold (step 348). In one example, the predetermined probability may be equal to seventy-five percent and the predetermined threshold of step 348 is equal to approximately a nominal road class or average lane width; however, this may vary in other embodiments.

As a further example, the right adjacent lane 406 is determined to be drivable if data as to the third lane marker 413 and the fourth lane marker 414 are available, the first lane marker 411 is determined to be dashed with at least a seventy five percent probability, and an absolute value of a difference between the above-referenced second lane marker 412 offset (i.e., an offset or distance between the vehicle 100 and the second lane marker 412) and the above-referenced first lane marker 411 offset (i.e., an offset or distance between the vehicle 100 and the first lane marker 411) is greater than a predetermined threshold (step 350). In one example, the predetermined threshold of step 350 is equal to approximately a nominal road class or average lane width; however, this may vary in other embodiments. In addition, in various embodiments, one or more other rules may be utilized (step 352).

With reference again to step 310, once it is determined in step 310 that the vehicle is travelling on a highway, the process also proceeds along a third path 313 beginning with step 354. During step 354, a determination is made as to whether camera data is available for lane markers of lanes that are adjacent to the vehicle. Similar to the above-described steps 320 and 334, the determination of step 354 is preferably made by the processor 250 of FIG. 2 with respect to whether the camera data of step 304 is available from the cameras 212 of FIG. 2 for lane markers of the adjacent lanes on the highway.

If it is determined in step 354 that the camera data is available, then the camera data is used to determine the lane markers for the highway (step 355). The lane markers are preferably identified or determined in this manner by the processor 250 of FIG. 2 using the camera data of step 304 from the camera 212 of FIG. 2. The process then proceeds to step 360, discussed further below, using the lane markers that are determined using the camera data.

Conversely, if it is determined in step 354 that the camera data is not available, then the lane markers are approximated using average or standard lane widths in steps 356-358. Specifically, during step 356, a projected path is determined for the vehicle. The projected path is preferably determined by the processor 250 of FIG. 2 using values of the position of the vehicle over time intervals as obtained from the sensor array 206 (e.g., via the accelerometers 240 of FIG. 2) and/or from the communication unit 204 of FIG. 2 (e.g., from a GPS device). Based on the projected path, the lane markers are constructed using a standard or average width for the lanes, preferably by the processor 250 of FIG. 2. Similar to the discussion above with respect to step 324, in certain embodiments, the average width is stored as one of the stored values 262 in the memory 252 of FIG. 2, for example as obtained via the map data, prior history, vehicle to vehicle communications, and/or vehicle to infrastructure communications discussed above. In some embodiments, the average lane width pertains to a known average width of lanes of the highway. In other embodiments, the average lane width pertains to an average width of lanes generally, across various roadway. The process then proceeds to step 360, discussed below.

During step 360, the movement or non-movement of one or more other vehicles and/or objects are tracked in adjacent lanes. In one embodiment, the radar data of step 306 is used to track other vehicles as they travel in the left adjacent lane 408 and the right adjacent lane 406 of FIG. 4. In other embodiments, camera, laser, ultrasound and/or other data may likewise be used. The processor 250 of FIG. 2 tracks the values over time in order track movement of other vehicles in adjacent lanes (such as the tracking of the movement of other vehicle 415 in the right adjacent lane 406 of FIG. 4). In a preferred embodiment, the processor 250 uses a known “bread crumbs” technique to track a direction of movement of other vehicles in the adjacent lanes, for example as represented by the bread crumbs 416 for the other vehicle 415 in the right adjacent lane 406 of FIG. 4. In certain embodiments, such bread crumbs 416 may also be used to track stationary vehicles or other objects in the adjacent lanes.

A confirmation is made as to whether the data of step 360 (e.g. the bread crumb data) is available (step 362). This determination is preferably made by the processor 250 of FIG. 2. If the data is not yet available, then step 362 repeats until the data becomes available.

Once the data of step 360 (e.g., the bread crumb data) becomes available, determinations are made as to whether the tracked vehicle locations (e.g. bread crumbs) fall within one of the adjacent lanes (step 364). Specifically, in one embodiment, the processor 250 of FIG. 2 determines in step 364 whether the bread crumbs of step 360 fall within the lane markers determined in step 355 (if the camera data was available in step 354) or in step 358 (if the camera data was not available in step 354). With further reference to FIG. 4, the processor 250 of FIG. 2 preferably determines whether the bread crumbs 416 for the other vehicle 415 fall between the first and second lane markers 411, 412 (in which case the other vehicle 415 would be determined to be in the left adjacent lane 408) or between the third and fourth lane markers 413, 414 (in which case the other vehicle 415 would be determined to be in the right adjacent lane 406 of FIG. 4).

A tally is kept as to a number of bread crumbs that fall within each of the adjacent lanes (step 366). Preferably, this tally is kept for both the left adjacent lane 408 and the right adjacent lane 406 of FIG. 4 (and preferably also for lanes that are adjacent to the adjacent lanes, so that “n” number of adjacent lanes may be considered) by the processor 250 of FIG. 2 using the data of step 364.

The tally of step 366 is then used to determine whether the adjacent lanes are drivable (step 368). Specifically, in a preferred embodiment, the left adjacent lane 408 of FIG. 4 is determined to be drivable if the number of bread crumbs 416 located between the first lane marker 411 and the second lane marker 412 of FIG. 4 is greater than a particular threshold value over a period of time, while the left adjacent lane 408 of FIG. 4 is considered to be un-drivable if the number of bread crumbs 416 located between the first lane marker 411 and the second lane marker 412 of FIG. 4 is less than the particular threshold value over the period of time. Similarly, in a preferred embodiment, the right adjacent lane 406 of FIG. 4 is determined to be drivable if the number of bread crumbs 416 located between the third lane marker 413 and the fourth lane marker 414 of FIG. 4 is greater than the particular threshold value over the period of time, while the right adjacent lane 406 of FIG. 4 is considered to be un-drivable if the number of bread crumbs 416 located between the third lane marker 413 and the fourth lane marker 414 of FIG. 4 is less than the particular threshold value over the period of time. These determinations are preferably made by the processor 250 of FIG. 2.

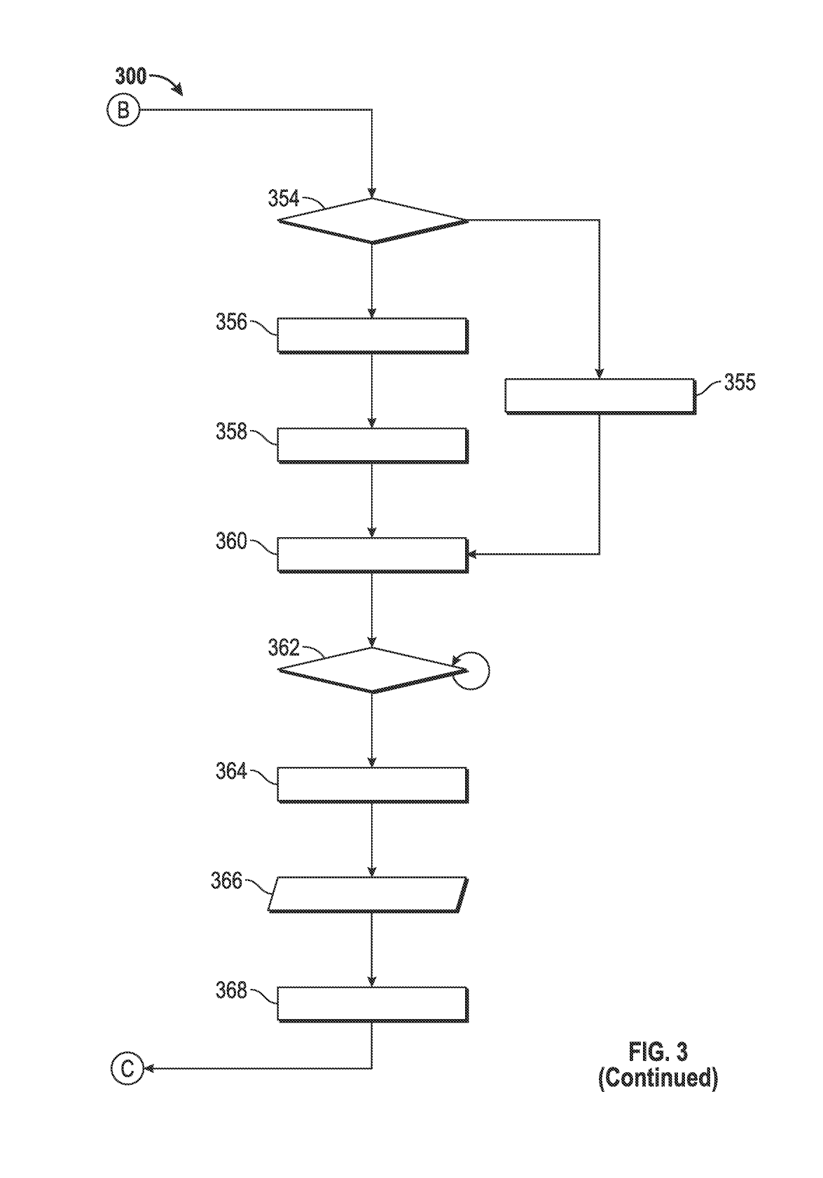

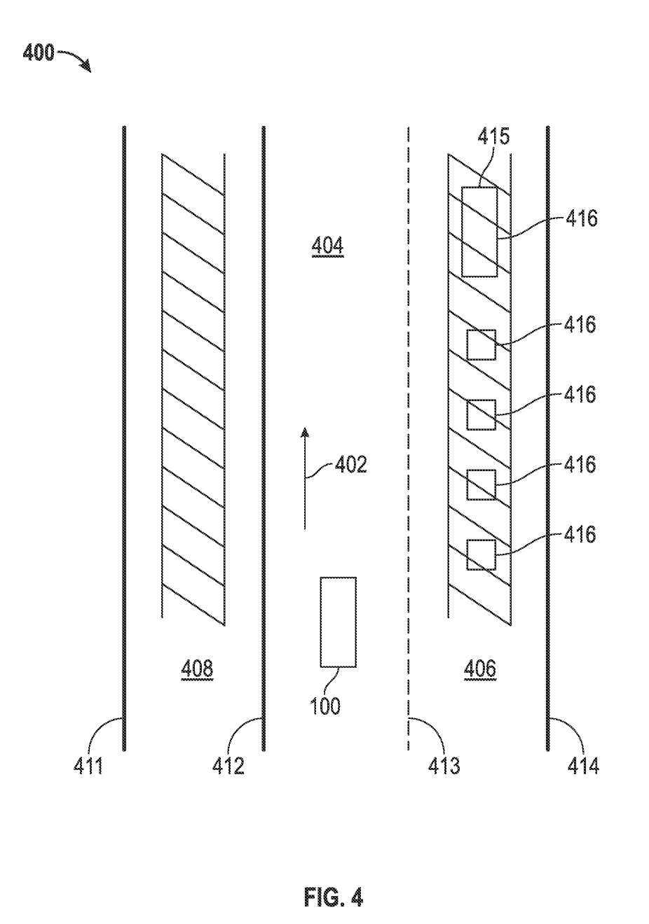

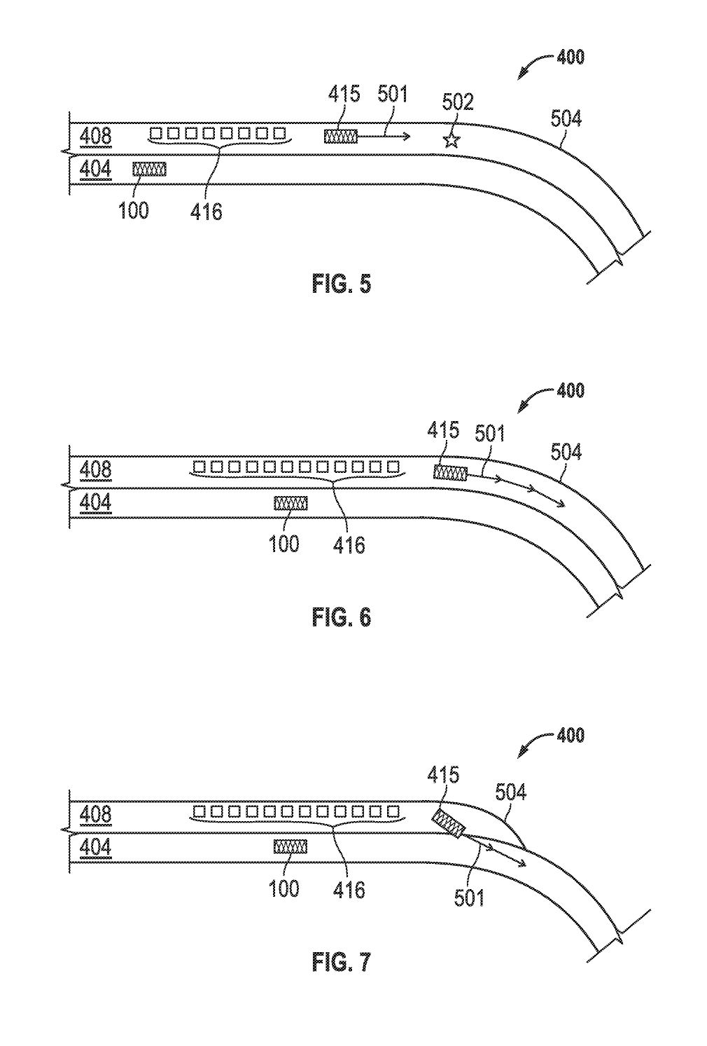

FIGS. 5-7 depict further illustrations and implementations of the process 300 of FIG. 3, including the use of breadcrumbs and the tracking of other vehicles in determining whether the adjacent lanes are drivable for step 368. As shown in FIGS. 5-7, the breadcrumbs 416 for the second vehicle 415 are used to track the second vehicle 415 and to estimate a forward trajectory 501 of the second vehicle 415 at locations in front of the host vehicle 100. The forward trajectory 501 of the second vehicle 415 can also be combined with map data points 502 from the map data and/or from other sources (e.g. from a central server, vehicle to vehicle communications, or the like) as to expected curvatures in the roadway (for example, with respect to an adjacent lane, such as lane 408 as depicted in FIGS. 5-7). For example, with reference to FIG. 5, the map data point 502 is used by the processor of the host vehicle 100 to identify a curve 504 in the roadway 400 (including adjacent lane 408), so that the processor can better predict the forward trajectory 501 of the second vehicle 415 along the curve 504. By way of additional example, with respect to FIG. 6, if the map data point is unavailable, the processor of the host vehicle may ascertain a curvature in the forward trajectory 501 of the host vehicle 415 and then use this forward trajectory as information to identify the upcoming curvature 504 in the roadway (including, in the depicted example, a curvature 504 that effects both the host vehicle lane 404 and adjacent lane 408). By way of further example, with respect to FIG. 7, the processor may use the forward trajectory 501 of the host vehicle 415 (in combination with any available map data or other available data, such as from vehicle to vehicle communications and/or communications via a central server) to identify that the curve 504 represents a merging of adjacent lane 408 with the host vehicle lane 404 (for example, such a merging of lanes may be permanent, or may be temporary due to an accident, construction, or the like). This information may similarly be used in assessing the drivability of adjacent lanes.

Returning to FIG. 3, the data from the second and third paths 312, 313 of the process 300 of FIG. 3 are then compared (step 370). Specifically, in a preferred embodiment, the processor 250 of FIG. 2 compares the drivability results of the second path 312 (e.g. as determined in steps 340-352) as to which adjacent lanes are determined to be drivable with the drivability results of the second path 313 (e.g. as determined in step 368). In addition, if available, such results are also fused with available global positioning system (GPS) data, map data, camera data, radar data, LIDAR data, and ultrasound data. In addition, other data may also be obtained and used in the fusion of data, including information obtained from a map database (for example, via a central server that is remote from the vehicle and that communicates wirelessly with the vehicle), vehicle to vehicle information (e.g., information from a leading vehicle that is transmitted back to the host vehicle), and/or a telematics interface (e.g. with information regarding known construction activity and/or lane closures). The combination or fusion of this data is used to generate confidence intervals for the drivability for the left adjacent lane 408 and the right adjacent lane 406 of FIG. 4. In certain embodiments, the fusion of data is accomplished using weighted averages of historical data, higher order algorithms including Kalman and/or Markov algorithms, and/or one or more learning algorithms including fuzzy logic and/or artificial intelligence. In one embodiment, a prediction is made as to the drivability for the adjacent lane forward of a current position of the vehicle by comparing a known curvature of the adjacent lane using map data and an expected trajectory of the second vehicle. In addition, in certain embodiments, the width of the adjacent lines is ascertained (e.g. using the bread crumb data, camera, and/or radar data), and the adjacent lane is considered to be drivable only the further condition that the width of the adjacent lane is greater than a predetermined threshold (in one such embodiment, the threshold may be equal to approximately 2.8 meters; however, this may vary in other embodiments). As mentioned above, as used in this Application, an adjacent lane is “drivable” if the vehicle would likely be able to safely move into such adjacent lane if desired or necessary (or, alternatively stated, that the adjacent lane is suitable for travel in the same direction in which the vehicle is travelling). This information may be used, for example, by the driver and/or by an automatic safety feature in deciding whether to change lanes in the event of a possible threat, such as a possible collision that may be avoided by a lane change, by way of example.

In certain embodiments, one or more actions are taken based on the data and results from the first and second paths 312, 313 and the determinations of step 370 (step 372). The actions may comprise an audio and/or visual notification (such as a verbal and/or audible notification provided by the driver notification unit 208 of FIG. 2. In addition, the action may include one or more remedial actions under certain conditions, for example via an active safety procedure such as, by way of example, a collision imminent braking system (CIB), collision preparation system (CPS), enhanced collision avoidance (ECA) system, adaptive cruise control (ACC), lane keep assist (LKA), lane centering (LC), or forward collision alert (FCA).

Accordingly, methods and systems are provided for making lane determinations pertaining to a vehicle that is being driving on a highway. The lane determinations include a current lane in which the vehicle is travelling on the highway, as well as a drivability of adjacent lanes on the highway.

It will be appreciated that the disclosed methods, systems, and vehicles may vary from those depicted in the Figures and described herein. For example, the vehicle 100, control system 170, and/or various components thereof may vary from that depicted in FIGS. 1 and 2 and described in connection therewith. In addition, it will be appreciated that certain steps of the process 300 may vary from those depicted in FIGS. 3-7 and/or described above in connection therewith. It will similarly be appreciated that certain steps of the process described above (and/or sub-processes or sub-steps thereof) may occur simultaneously or in a different order than that depicted in FIGS. 3-7 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof

We claim:

1. A method comprising:
determining a lane of a roadway in which a vehicle is travelling;
identifying an adjacent lane that is adjacent to the lane in which the vehicle is travelling; and
assessing a drivability of the adjacent lane using a processor.

2. The method of claim 1, further comprising:
determining a lateral displacement of a vehicle while the vehicle is travelling along a roadway;
wherein the step of determining the lane comprises determining the lane using the lateral displacement.

3. The method of claim 2, wherein the step of determining the lateral displacement comprises determining a relative lateral displacement of the vehicle with respect to a lane marker on the roadway using data from a camera of the vehicle.

4. The method of claim 2, wherein the step of determining the lane comprises making a first determination as to the lane based at least in part on the lateral displacement, and the method further comprises:
making a second determination as to within which of the lanes the vehicle is travelling based at least in part on radar, laser or ultrasound data pertaining to an edge or a guard rail of the roadway; and
comparing the first determination with the second determination.

5. The method of claim 2, wherein the step of determining the lane comprises making a first determination as to the lane based at least in part on the lateral displacement, and the method further comprises:
making a second determination as to the lane based at least in part on map data from a map of the roadway or from a global positioning system (GPS) device; and
comparing the first determination with the second determination.

6. The method of claim 1, further comprising:
determining whether an entrance for the roadway is on a right side or a left side of the vehicle;
wherein the step of determining the lane comprises determining the lane based at least in part on the entrance.

7. The method of claim 1, wherein the step of assessing the drivability of the adjacent lane comprises:
determining one or more physical characteristics of a lane marker for the adjacent lane using data from a camera or a Lidar device of the vehicle; and
determining a likelihood that the adjacent lane is suitable for travel in the same direction in which the vehicle is travelling using the one or more physical characteristics.

8. The method of claim 7, wherein the step of determining one or more physical characteristics comprises determining whether the lane marker comprises a dashed line versus a solid line, a width of the lane marker, or both.

9. The method of claim 7, wherein the step of determining one or more physical characteristics comprises determining a color of the lane marker, a width of the lane marker, or both.

10. The method of claim 1, wherein the step of assessing the drivability of the adjacent lane comprises:
determining one or more physical characteristics of known structures of the roadway, the known structures comprising one or more of a guard rail, a pole, a pole, a median, a light, a barrier, or a sign post; and
determining a likelihood that the adjacent lane is suitable for travel in the same direction in which the vehicle is travelling using the one or more physical characteristics.

11. The method of claim 1, further comprising:
tracking movement or non-movement of a second vehicle driven in the adjacent lane that is adjacent to the lane in which the vehicle is travelling; and
determining a likelihood that the adjacent lane is suitable for travel in the same direction based at least in part of the tracking.

12. The method of claim 11, further comprising:
estimating a trajectory of the second vehicle; and
predicting drivability for the adjacent lane forward of a current position of the vehicle by comparing a known curvature of the adjacent lane using map data and the expected trajectory of the second vehicle.

13. A system comprising:
a sensing unit configured to obtain sensing unit data; and
a processor coupled to the sensing unit and configured to, using the sensing unit data:
determine a lane of a roadway in which a vehicle is travelling;
identify an adjacent lane that is adjacent to the lane in which the vehicle is travelling; and
assess a drivability of the adjacent lane.

14. The system of claim 13, wherein:
the sensing unit is configured to obtain sensing unit data pertaining to a lateral displacement of the vehicle; and
the processor is configured to determine the lane using the lateral displacement.

15. The system of claim 14, wherein the processor is configured to:
make a first determination as to the lane based at least in part on the lateral displacement;
make a second determination as to within which of the lanes the vehicle is travelling based at least in part on radar, laser or ultrasound data pertaining to an edge or a guard rail of the roadway; and
compare the first determination with the second determination.

16. The system of claim 14, wherein the processor is configured to:
make a first determination as to the lane based at least in part on the lateral displacement;
make a second determination as to the lane based at least in part on map data from a map of the roadway or from a global positioning system (GPS) device; and
compare the first determination with the second determination.

17. The system of claim 13, wherein the processor is configured to:
determine one or more physical characteristics of a lane marker for the adjacent lane using camera data from a camera of the vehicle; and
determine a likelihood that the adjacent lane is suitable for travel in the same direction in which the vehicle is travelling using the one or more physical characteristics.

18. The system of claim 13, wherein the processor is configured to:
determine one or more physical characteristics of known structures of the roadway using the sensing unit data, the known structures comprising one or more of a guard rail, a pole, a pole, a median, a light, a barrier, or a sign post; and
determine a likelihood that the adjacent lane is suitable for travel in the same direction in which the vehicle is travelling using the one or more physical characteristics.

19. The system of claim 13, wherein the processor is further configured to:
track movement or non-movement of a second vehicle driven in the adjacent lane that is adjacent to the lane in which the vehicle is travelling using the sensing unit data; and
determine a likelihood that the adjacent lane is suitable for travel in the same direction based at least in part of the tracking.

20. The system of claim 19, wherein the processor is further configured to:
estimate a trajectory of the second vehicle; and
predict drivability for the adjacent lane forward of a current position of the vehicle by comparing a known curvature of the adjacent lane using map data and the expected trajectory of the second vehicle.
